(19) United States
(12) Patent Application Publication
(10) Pub. No.: US 2008/0120182 A1
(43) Pub. Date: May 22, 2008

(54) METHODS AND SYSTEMS FOR PROVIDING PERSONALIZED INFORMATION

(75) Inventors: Deborah Arnold, Loomis, CA (US); Doug Deibert, Alameda, CA (US); Charles Quach, Pacifica, CA (US); Christine Ring, San Carlos, CA (US); Roberta Lee, Redwood City, CA (US)

Correspondence Address: MAYER BROWN LLP, P.O. BOX 2828, CHICAGO, IL, 60690, US

(73) Assignee: Visa International Service Association, Foster City, CA (US)

(21) Appl. No.: 11/749,566

(22) Filed: May 16, 2007

Related U.S. Application Data
(60) Provisional application No. 60/747,333, filed on May 16, 2006.

(51) Int. Cl. G06Q 30/00; G06Q 99/00

(52) U.S. Cl. 705/14; 705/1

(57) ABSTRACT

A system and method for providing personalized information to a consumer includes a contactless device containing electronic consumer data, a contactless device reader, a service platform connected to the contactless device reader for processing the consumer data and creating customized information from the consumer data, and an output device including a display for outputting the customized information to the consumer.

### FIELD OF THE INVENTION

The present invention relates to systems for providing instant personalized information to a consumer based on the specific content of an individual consumer's stored personal data.

### BACKGROUND OF THE INVENTION

Information is often presented to a consumer to encourage the consumer to, for example, purchase an item. However, such information is typically provided in the same manner to all consumers. For example, a displayed sign in a retail environment may advertise an item that is for sale. However, the sign might not display a different sale item in which a particular consumer would be interested. Accordingly, because the consumer might not be aware of the item for sale, no transaction would occur.

In addition, individuals that travel abroad often cannot comprehend the principal language of the country in which they are traveling. As such, travelers are often unaware of what particular merchants offer for sale, how much such items cost and the like. Many travelers would prefer to have the ability to determine what the merchant is offering in their native language and/or native currency. However, such information is not available using conventional means.

Moreover, many event attendees would prefer to receive information specific to them regarding the event that they are attending. For example, an event attendee might desire to know the location of a seat assigned to him for the event, information regarding a performer and the like. Such information would preferably be displayed in a manner most amenable to each particular event attendee as well.

What are needed are methods and systems for providing personalized information to a consumer in a purchasing environment.

A further need exists for methods and systems for providing personalized information to a consumer based on one or more preferences specified by or for a user.

The present disclosure is directed to solving one or more of the above-listed problems.

### SUMMARY OF THE INVENTION

Before the present methods are described, it is to be understood that this invention is not limited to the particular, methodologies or protocols described, as these may vary. It is also to be understood that the terminology used herein is for the purpose of describing particular embodiments only, and is not intended to limit the scope of the present disclosure, which will be limited only by the appended claims.

It must be noted that as used herein and in the appended claims, the singular forms “a,” “an,” and “the” include plural reference unless the context clearly dictates otherwise. Thus, for example, reference to a “transaction” is a reference to one or more transactions and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of the present invention, the preferred methods, devices, and materials are now described. All publications mentioned herein are incorporated herein by reference. Nothing herein is to be construed as an admission that the invention is not entitled to antedate such disclosure by virtue of prior invention.

In an embodiment, a method for providing personalized information may include receiving personalized information for an individual from a token, using the information to selecting one or more items to display to the user and/or one or more formats in which to display the one or more items, and displaying at least one selected item to the user. In an embodiment, the at least one selected item may be displayed in a selected format. In an embodiment, the information may be transmitted wirelessly from the token to a reader. In an embodiment, the at least one selected item may be displayed on the token. In an embodiment, the at least one selected item may be displayed on a display in communication with the reader.

### BRIEF DESCRIPTION OF THE DRAWINGS

Aspects, features, benefits and advantages of the present invention will be apparent with regard to the following description and accompanying drawings, of which:

FIG. 1 depicts a flow diagram for an exemplary method of providing personalized information to a consumer according to an embodiment.

FIG. 2 depicts an exemplary system-level diagram of a smart billboard system according to an embodiment in which the contactless device reader is embedded in the display device.

FIG. 3 depicts an alternate exemplary system-level diagram of a smart billboard system according to an embodiment in which the contactless device reader is separate from the display device.

### DETAILED DESCRIPTION OF THE INVENTION

A smart billboard system may include a traditional display screen in communication with, for example, a contactless reader and/or a processor. In an embodiment, the processor may reside within a laptop computer, a personal computer or a server computer system. Software, hardware or a combination thereof may be used to operate the smart billboard. If used, software may reside in a storage medium in communication with the processor and hardware may be in communication with the processor.

A contactless device, such as a contactless card, a cellular phone, a personal digital assistant (PDA), a key fob and/or the like, may include, for example, a storage medium containing programming instructions for allowing the contactless device to engage in a contactless payment method. The storage medium may further contain one or more fields personalized for a consumer using the contactless device. Such fields may include information customized for the consumer, such as a home currency, a preferred language, a favorite type of food and/or other preference based information. When such a contactless device is proximate to a contactless reader, the reader may request, receive and process the information in at least one field in order to display personalized information for the consumer.

In an embodiment, a traditional magnetic stripe/smart card and contact-based card reader may also be used within the scope of the present disclosure as will be apparent to those of ordinary skill in the art. In such an embodiment, the card may be brought into contact with the card reader to initiate the process of displaying personalized information. For simplicity, the remainder of this disclosure merely refers to a contactless device and contactless card reader. Modifications, if any, required to be made to the disclosed embodiments to enable contact-based systems and methods will be apparent to those of ordinary skill in the art.

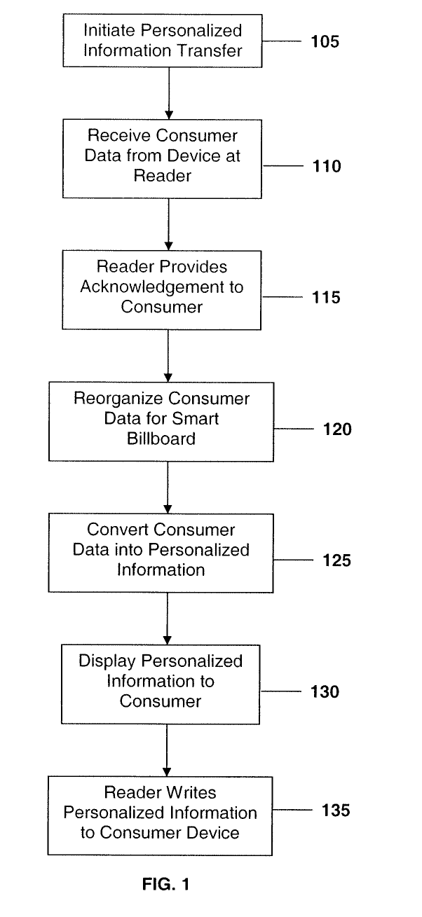

FIG. 1 depicts a flow diagram for an exemplary method of providing personalized information to a consumer according to an embodiment. As shown in FIG. 1, a consumer having a contactless device that stores personalized information may enter into an area proximate to a smart billboard system and present 105 the contactless device to a contactless reader. In an embodiment, the interaction between the contactless device and the contactless reader may be performed using wireless technology, such as a contactless transaction based on the ISO 14443 standard, Near Field communication, Bluetooth and/or any other wireless or contactless protocol.

The reader may request and receive 110 consumer data from the contactless device. Upon receipt of the consumer data, the reader may optionally provide 115 an acknowledgement to the consumer. For example, the reader may provide an audible signal and/or a visual signal to the consumer.

In an embodiment, the data received from the contactless device may be in a “raw” format according to common data standards, such as EMV or ISO. As such, the raw data may be parsed 120 to organize and structure the data into a format that may be used by the smart billboard system. For example, the raw data may be reformatted into an XML structure and/or a flash programming language.

The smart billboard system may use one or more of basic consumer data, such as the cardholder's first name, last name and the like, and enhanced consumer data, Such as a cardholder's Country of residence, preferred language, preferred currency and the like, to convert 125 the basic and/or static information into value-added and/or customized information for the consumer. The value-added and/or customized information may then be delivered 130 to the consumer via a display device, such as a television, a computer monitor, a printer, speakers, a display on the contactless device, or through other means for the consumer to receive such information visually or aurally. In an embodiment, sound may also be provided 130 to the consumer. The smart billboard system may also write 135 the value-added and/or customized information to the contactless device.

For example, a consumer fluent only in English that is using a contactless device according to an embodiment and traveling in China may enter a restaurant. The contactless device may include preference-based information listing English as the primary language for the consumer. If the consumer is proximate to a smart billboard system that typically displays a menu in Chinese, a contactless reader associated with the smart billboard system may detect the preference-based information on the consumer's contactless device and translate the menu into English. If a preferred currency for the consumer is also stored on the contactless device, the smart billboard system may calculate the prices for the menu items in the preferred currency based on, for example, real-time exchange rates. Other operations may additionally or alternately be performed within the scope of the present disclosure.

In another example, an event ticket may be purchased by a consumer using a contactless device according to an embodiment. A record of the purchase may be transmitted to the contactless device at the time of purchase. When the consumer enters a ticket gate in which a contactless reader is installed, the ticket may be redeemed from the contactless device and a display attached to the reader or otherwise visible to the consumer may, for example, welcome the consumer and provide directions to the consumer's seat. Other operations may additionally or alternately be performed within the scope of the present disclosure.

In yet another example, a merchant may personalize a contactless device with personal preferences for a consumer. When the contactless device is detected by a smart billboard system, information and/or offers related to the consumer's preferences for the merchant's products may be displayed. For example, a music provider may assign preference information detailing favored artists, favored music styles and/or the like for the consumer to a contactless device. When the consumer enters a music store, new releases and/or sales on offerings from a favored artist and/or related artists may be displayed on a display in proximity to the user. Other operations may additionally or alternately be performed within the scope of the present disclosure.

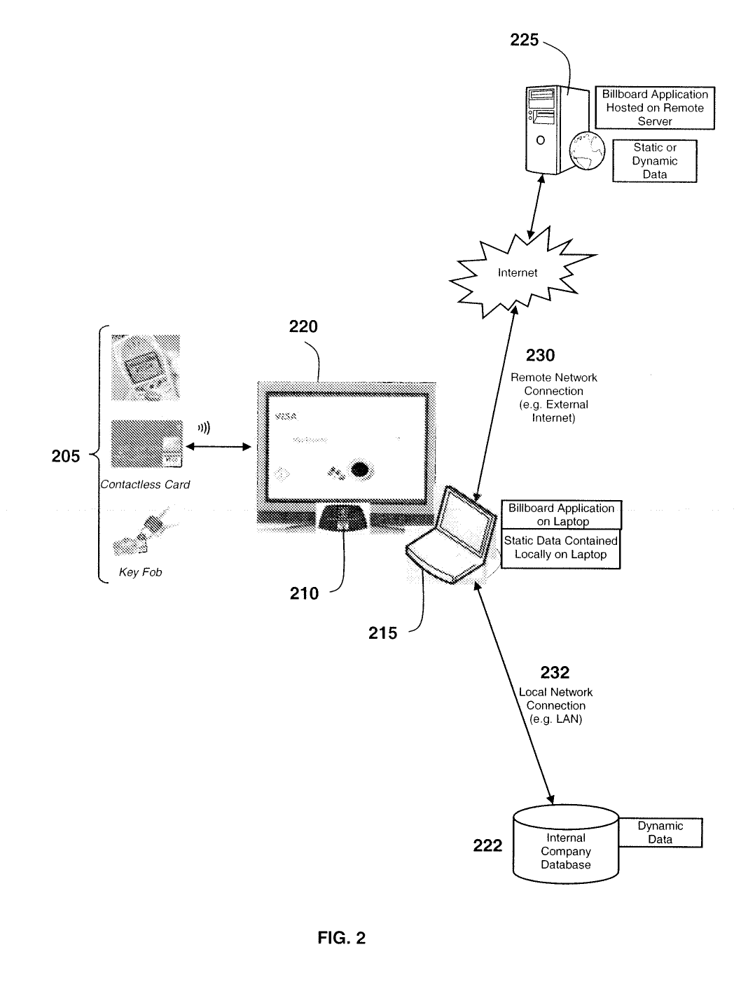

FIG. 2 depicts an exemplary system-level diagram of a smart billboard system according to an embodiment. As shown in FIG. 2, the smart billboard system may include a contactless device 205, a contactless reader 210, a computer system 215 including software for operating the smart billboard, and an output device 220. The contactless device 205 may be accessed by the contactless reader 210 to provide personalized information to the reader. The reader 210 may transmit the personalized information to the computer system 215, which may include, for example, a laptop computer having a storage medium. The computer system 215 may process the data and output a personalized message to, for example, an output device 220. In an embodiment, the computer system 215 may further transmit data to the reader 210. The reader 210 may likewise forward at least a portion of the information to the contactless device 205. For example, the contactless reader 210 may upload new data, such as a coupon and/or updated loyalty points, to the contactless device 205 as part of a transaction.

In an embodiment, one or more of the contactless reader 210, computer system 215 and output device 220 may be combined into a combined system (See FIG. 2). For example, the contactless reader 210 may be embedded into the output device 220. An output device 220 may include, for example and without limitation, a display, a printer and/or a speaker. To allow for additional interaction between the user and the smart billboard system, a touch screen may be incorporated into the output device 220 (e.g., display) to allow users to provide additional information during the interaction. In an alternate embodiment, multiple device readers 210 and multiple output devices 220 may be added to a single system as needed in order to simultaneously deliver different customized information to multiple consumers, who each have a contactless device 205, and are located at various locations within the same facility. The single computer system 215 would be connected to each of the multiple device readers 210 and output devices 220 and would be able to determine which consumer is proximate to each of the multiple device readers 210 and output devices 220. The computer system 215 would then deliver the customized information of each individual consumer to the appropriate output device 220 proximate to each of the multiple consumers.

In yet another embodiment, the computer system 215 may obtain and analyze data from, and generate data for, a plurality of sources. For example, as described above, the computer system 215 may obtain data from the contactless device 205 via the contactless reader 210. In addition, the computer system 215 may access static data, dynamic data and/or real-time data.

In an embodiment, the computer system 215 where the smart billboard application resides may be a laptop computer. The smart billboard application may access static data that resides locally in the laptop or use a Remote Network Connection (e.g., over the Internet) 230 to access static or dynamic data contained on a Remote Server 225. Alternatively, the smart billboard application can go through a local area network (LAN) connection 232 to retrieve static or dynamic data that resides elsewhere, for example an internal company database 222.

In an embodiment, dynamic data may include data that is associated with a user and that is updated periodically and/or the latest data available from a source external to computer system 215, such as an internal company database 222, or a remote server 225. In an embodiment, dynamic data may include, without limitation, loyalty points for the consumer, a credit balance remaining for an account associated with the contactless device and/or the like.

In an embodiment, real-time data is data that is not necessarily associated with any single user, but data which changes over time. Real-time data may be obtained from an external database or alternate sources accessible, for example, via the Internet. This external database need not be maintained by the same party who maintains remote server 225. In an embodiment, real-time data may include, without limitation, a real-time currency conversion rate, a stock quote and/or the like.

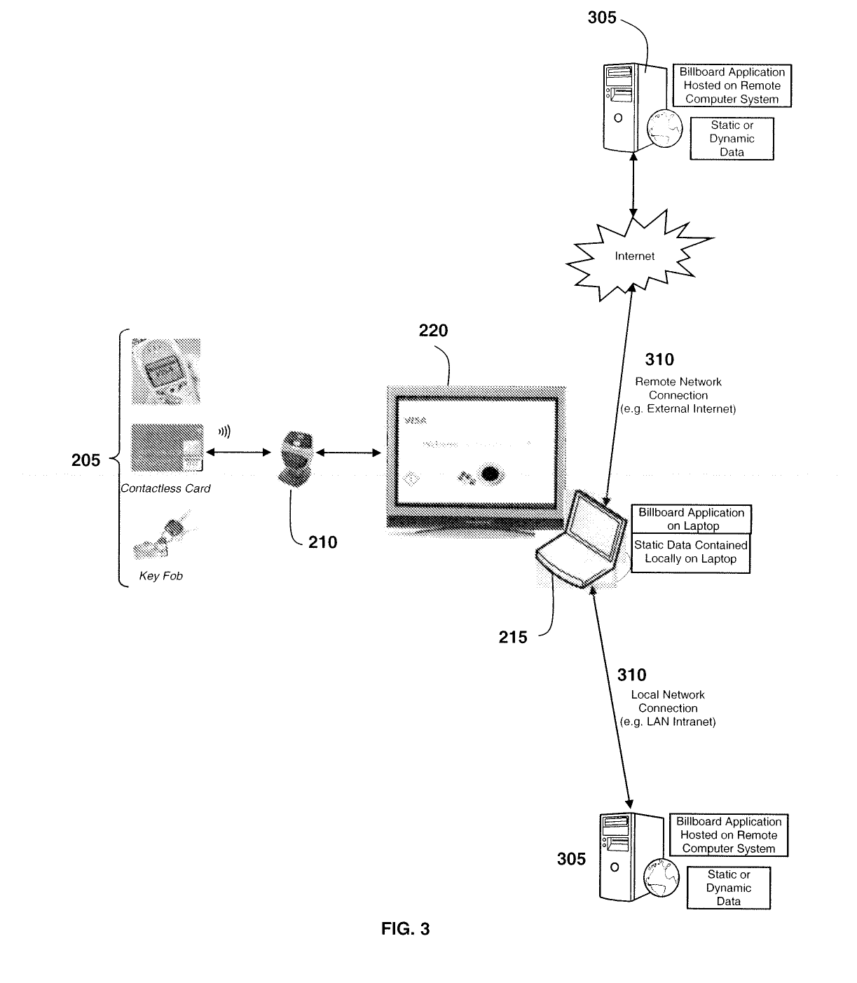

FIG. 3 depicts an alternate exemplary system-level diagram of a smart billboard system according to an embodiment. As shown in FIG. 3, the contactless reader 210 and the output device 220 may be located at a particular location accessible by a consumer having a contactless device 205. When the consumer's contactless device 205 is proximate to the contactless reader 210, the reader may request and receive information from the contactless device 205. The reader may transmit the information to a remote computer system 305 via a communication network 310, such as the Internet and/or an intranet. The remote computer system 305 may receive and analyze the information provided by the contactless reader 210 and transmit personalized information to the output device 220 via the communication network 310. Such an embodiment may reduce the cost of implementing a smart billboard system since the remote computer system 305 may control data displayed on a plurality of output devices, such as 220, at a plurality of locations.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may he subsequently made by those skilled in the art which are also intended to be encompassed by the disclosed embodiments.

What is claimed is:

1. A system for providing personalized information to a consumer comprising:
a consumer information device containing electronic consumer data;
a consumer information device reader for requesting and reading said consumer data contained on said consumer information device;
a service platform connected to said information device reader for receiving said consumer data transmitted from said device reader, processing said consumer data, and creating customized information from said consumer data to be provided to said consumer; and
at least one output device connected to said service platform for receiving said customized information transmitted from said service platform, and outputting said customized information to said consumer.

2. The system of claim 1, wherein said electronic consumer data includes personal information of said consumer.

3. The system of claim 1, wherein said service platform includes a computer system and software for processing said consumer data and creating said customized information to be provided to said consumer.

4. The system of claim 3, wherein said consumer information device includes a storage medium

5. The system of claim 4, wherein said consumer information device is a contactless device and said device reader is a contactless device reader.

6. The system of claim 3, wherein said computer system transmits at least a portion of said customized information to said device reader, and said device reader transmits said portion of said customized information to said consumer information device.

7. The system of claim 1, wherein said device reader is embedded in said output device.

8. The system of claim 1, wherein said output device includes at least one display device for visually displaying said customized information to said consumer.

9. The system of claim 8, wherein said output device includes at least one speaker for broadcasting customized audio information to said consumer.

10. A method for providing personalized information to a consumer comprising the steps of:
storing electronic consumer data on a consumer information device;
presenting said consumer information device to a consumer information device reader;
requesting and reading said electronic consumer data from said consumer information device with said device reader;
transmitting said consumer data from said device reader to a service platform;
creating customized information in said service platform from said electronic consumer data;
transmitting said customized information to an output device;
outputting said customized information to said consumer.

11. The method of claim 10, further comprising transmitting at least a portion of said customized information from said service platform to said information device reader, and transmitting said customized information from said information device reader to said consumer information device for storage on said device.

12. The method of claim 10, further comprising said device reader providing acknowledgement of said consumer to said consumer.

13. The method of claim 10, wherein presenting said consumer information device to a consumer information device reader includes the step of bringing a contactless device proximate to a contactless device reader.

14. The method of claim 10, wherein outputting said customized information to said consumer includes displaying customized visual information on at least one display device.

15. The method of claim 14, wherein outputting said customized information to said consumer includes broadcasting customized audio information from at least one audio speaker.

16. The method of claim 10, wherein said electronic consumer data includes one or more of a name, country of residence, preferred language, preferred currency, and personal consumer purchasing preferences.

17. The method of claim 10, wherein said customized consumer information includes suggestions as to potential purchases to be made by said consumer.
